(19) United States
(12) Patent Application Publication
(10) Pub. No.: US 2021/0120355 A1
(43) Pub. Date: Apr. 22, 2021

(54) APPARATUS AND METHOD FOR AUDIO SOURCE SEPARATION BASED ON CONVOLUTIONAL NEURAL NETWORK

(71) Applicant: Electronics and Telecommunications Research Institute, Daejeon (KR)

(72) Inventors: Hye Mi KIM, Daejeon (KR); Jung Hyun KIM, Daejeon (KR); Jee Hyun PARK, Daejeon (KR); Yong Seok SEO, Daejeon (KR); Dong Hyuck IM, Daejeon (KR); Won Young YOO, Daejeon (KR)

(73) Assignee: Electronics and Telecommunications Research Institute, Daejeon (KR)

(21) Appl. No.: 17/032,995

(22) Filed: Sep. 25, 2020

(30) Foreign Application Priority Data
Oct. 22, 2019 (KR) 10-2019-0131439

(51) Int. Cl. H04S 5/00; G10L 19/008; G10L 25/30

(52) U.S. Cl. CPC H04S 5/00; G10L 25/30; G10L 19/008

(57) ABSTRACT

A method for receiving a mono sound source audio signal including phase information as an input, and separating into a plurality of signals may comprise performing initial convolution and down-sampling on the inputted mono sound source audio signal; generating an encoded signal by encoding the inputted signal using at least one first dense block and at least one down-transition layer; generating a decoded signal by decoding the encoded signal using at least one second dense block and at least one up-transition layer; and performing final convolution and resize on the decoded signal.

### CROSS-REFERENCE TO RELATED APPLICATIONS

This application claims priority to Korean Patent Application No. 10-2019-0131439 filed on Oct. 22, 2019 with the Korean Intellectual Property Office (KIPO), the entire contents of which are hereby incorporated by reference.

### BACKGROUND

### 1. Technical Field

The present disclosure relates generally to an apparatus and a method for separating an audio source, and more specifically, to an apparatus and a method for separating an audio source based on a convolutional neural network.

### 2. Related Art

The conventional service for identifying music in a smartphone was developed for a purpose of identifying a foreground sound with little noise based on a music fingerprinting technology. Among sound source separation technologies, a technology for extracting only a sound of a specific instrument or a voice of a specific singer from a mono sound source in which sounds of various instruments and voices of singers are mixed is being actively studied. There are public datasets for such the studies, and recently, a method using neural networks has been proposed. On the other hand, for the technology for extracting a background music included in a broadcasted content, there are two additional challenges to be solved.

The first challenge is for a case when a sound of a signal to be extracted is low. In case of dramas or entertainments, if a background music is inserted when an actor or performer speaks, the background music should be inserted in a sound that is small enough to hear the actor's dialogue so that the dialogue can be communicated well. In this reason, the background music is much smaller than the actor's dialogue in volume.

The second challenge is for a case when music includes human voices. In case of separating a sound source for each instrument, a unique characteristic of each instrument may be used. However, there may be a case of separating a dialogue from the music including human voices. Like this, if two classes to be separated share a signal itself, the separation performance may be degraded. Another problem when separating the dialogue is that human voices have different characteristics for all men and women, young and old, and individuals.

As described above, it is demanded to develop a high-performance sound source separation technology for separating sound sources having a similar vocalization structure such as a broadcast content.

### SUMMARY

Accordingly, exemplary embodiments of the present disclosure are directed to providing an audio source separation method based on a convolutional neural network.

Also, exemplary embodiments of the present disclosure also are directed to providing an audio source separation apparatus based on the audio source separation method.

According to an exemplary embodiment of the present disclosure, a method for receiving a mono sound source audio signal including phase information as an input, and separating into a plurality of signals may comprise performing initial convolution and down-sampling on the inputted mono sound source audio signal; generating an encoded signal by encoding the inputted signal using at least one first dense block and at least one down-transition layer; generating a decoded signal by decoding the encoded signal using at least one second dense block and at least one up-transition layer; and performing final convolution and resize on the decoded signal.

An output of each of the at least one first dense block may be connected to an output of a corresponding up-transition layer.

Each of the at least one first dense block and the at least one second dense block may include one or more convolutions performed on an input initial feature map, and a value obtained by concatenating a result of a first convolution on the initial feature map and the initial feature map is provided as an input of a second convolution.

The down-transition layer may perform convolution for reducing a number of feature maps output by each of the at least one first dense block; and down-sampling for feature maps output by the convolution for reducing the number of feature maps output by each of the at least one first dense block.

The up-transition layer may perform convolution for reducing a number of feature maps output by each of the at least one second dense block; and up-sampling for feature maps output by the convolution for reducing the number of feature maps output by each of the at least one second dense block.

The up-sampling may be performed to maintain an initial input length of an initial feature map by increasing a length of a feature vector by a length of the feature vector reduced through the down-transition layer.

The up-sampling may be performed through a bilinear resize.

Each of the initial convolution, the final convolution, convolution performed in the at least one first dense block, and convolution performed in the at least one second dense block may include batch normalization to normalize a distribution of batches, an activation function, and a one-dimensional convolution.

The method may further comprise outputting the plurality of signals including a feature map for each of the plurality of signals as a result of performing the final convolution and resize.

The resize on the decoded signal is performed in a manner of taking a first sample and discarding a second sample following the first sample.

Furthermore, according to an exemplary embodiment of the present disclosure, an apparatus for separating a mono sound source audio signal including phase information into a plurality of signals may comprise a processor; and a memory storing at least one instruction executable by the processor, wherein when executed by the processor, the at least one instruction may cause the processor to perform initial convolution and down-sampling on the inputted mono sound source audio signal; generate an encoded signal by encoding the inputted signal using at least one first dense block and at least one down-transition layer; generate a decoded signal by decoding the encoded signal using at least one second dense block and at least one up-transition layer; and perform final convolution and resize on the decoded signal.

An output of each of the at least one first dense block may be connected to an output of a corresponding up-transition layer.

Each of the at least one first dense block and the at least one second dense block may include one or more convolutions performed on an input initial feature map, and a value obtained by concatenating a result of a first convolution on the initial feature map and the initial feature map is provided as an input of a second convolution.

The down-transition layer may perform convolution for reducing a number of feature maps output by each of the at least one first dense block; and down-sampling for feature maps output by the convolution for reducing the number of feature maps output by each of the at least one first dense block.

The up-transition layer may perform convolution for reducing a number of feature maps output by each of the at least one second dense block; and up-sampling for feature maps output by the convolution for reducing the number of feature maps output by each of the at least one second dense block.

The up-sampling may be performed to maintain an initial input length of an initial feature map by increasing a length of a feature vector by a length of the feature vector reduced through the down-transition layer.

The up-sampling may be performed through a bilinear resize.

Each of the initial convolution, the final convolution, convolution performed in the at least one first dense block, and convolution performed in the at least one second dense block may include batch normalization to normalize a distribution of batches, an activation function, and a one-dimensional convolution.

The at least one instruction may further cause the processor to output the plurality of signals including a feature map for each of the plurality of signals as a result of performing the final convolution and resize.

The resize on the decoded signal may be performed in a manner of taking a first sample and discarding a second sample following the first sample.

According to the exemplary embodiments of the present disclosure as described above, a sound source including multiple voices having a similar vocalization structure, such as a broadcast content, can be separated with high performance.

### BRIEF DESCRIPTION OF DRAWINGS

Embodiments of the present disclosure will become more apparent by describing in detail embodiments of the present disclosure with reference to the accompanying drawings, in which:

FIG. 1 is a structural diagram of a convolutional neural network used for sound source separation according to an exemplary embodiment of the present disclosure;

FIG. 2 is a conceptual diagram of a dense block applied to the present disclosure;

FIG. 3 is a block diagram illustrating a convolution block according to an exemplary embodiment of the present disclosure;

FIG. 4 is a conceptual diagram of a down-transition layer according to an exemplary embodiment of the present disclosure;

FIG. 5 is a conceptual diagram of an up-transition layer according to an exemplary embodiment of the present disclosure;

FIG. 6 is a flowchart for describing a method for separating a sound source based on a convolutional neural network according to an exemplary embodiment of the present disclosure; and

FIG. 7 is a block diagram illustrating an apparatus for separating a sound source based on a convolutional neural network according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure includes a method of extracting only a singer's voice from a mono sound source in which sounds of various musical instruments and voices of singers are mixed. The exemplary embodiments of the present disclosure may be applied equally to not only a case of extracting a singer's voice but also a case of extracting a sound of one musical instrument. In addition, the exemplary embodiments of the present disclosure may also be applied to a case of separating a dialogue of actor or host from a background music when the dialogue of actor or host and the background music are mixed in a broadcast content, without being limited to the separation of sound sources from a music.

Here, a mono sound source is a result of converting music having stereo channels or post-processed broadcast audio signals into a single channel. In addition, a term ‘audio signal’ as used herein is used as a signal including a human voice, a music, a sound that can be collected from nature, a noise, and the like.

Hereinafter, preferred exemplary embodiments of the present disclosure will be described in detail with reference to the accompanying drawings.

In case of broadcasts such as dramas that are aired on television (TV), a music that appears in a background when an actor is talking is much smaller in volume than the actor's dialogue. Since the size of the music signal is very small, a mixed signal of a voice signal and a music signal and a corresponding music signal are different from each other. In such a situation when the dialogue and music are mixed, a performance of separating the music signal may be significantly deteriorated.

In this case, if a sound source separation technology is applied to separate the music from the dialogue and the music from which the dialogue has been removed is provided to a conventional music identifier, the problem of music identification performance degradation due to the actor's dialogue acting as a noise during the music identification can be solved. Among the sound source separation technologies, a technology for extracting only a sound of a specific instrument or a voice of a singer from a mono sound source in which sounds of various instruments and voices of singers are mixed is being actively studied. There are public datasets for such the studies, and recently, a method using neural networks has been proposed.

The techniques for performing sound source separation may be roughly classified into two types. One of them is a method of using an amplitude spectrogram obtained by performing Fourier transform on an input signal as an input, and the other of them is a method of using each sample information of a waveform signal as it is without any special processing.

A typical technology that uses a spectrogram as an input may use a method of separating a singer's voice from music based on a U-Net neural network. A typical technology that uses a sample waveform as an input may be a Wave-U-Net method, which also applies a U-Net neural network. The method using the spectrogram has the advantage that the amount of computation is relatively small, but the performance is limited because it does not handle phase information.

The U-Net neural network commonly used in both technologies is composed of a fully convolutional network and is a network composed of a structure of an encoding part and a decoding part. By configuring a skip connection between an encoding unit and a decoding unit of the same layer, sound source separation may be more elaborately performed. However, the U-Net neural network has a disadvantage that the number of parameters is large as the number of feature maps doubles while performing convolution.

Also, a DenseNet proposed in the field of object classification has a scheme of concatenating result values of all previous layers in a current dense block with a result value of a current layer, rather than concatenating only a result value of a previous layer with the result value of the current layer. It is known to perform better without constructing a deep neural network.

In the present disclosure, a waveform signal including phase information is used as an input signal, and a Wave-DenseNet method applicable to sound source separation, which is modified from the DenseNet proposed in the field of the object classification, is proposed to improve the sound source separation performance.

In exemplary embodiments described below, as an exemplary embodiment of the present disclosure for separating a sound source, a method of separating a background music and an actor's or performer's dialogue when they are mixed in a broadcast content will be described.

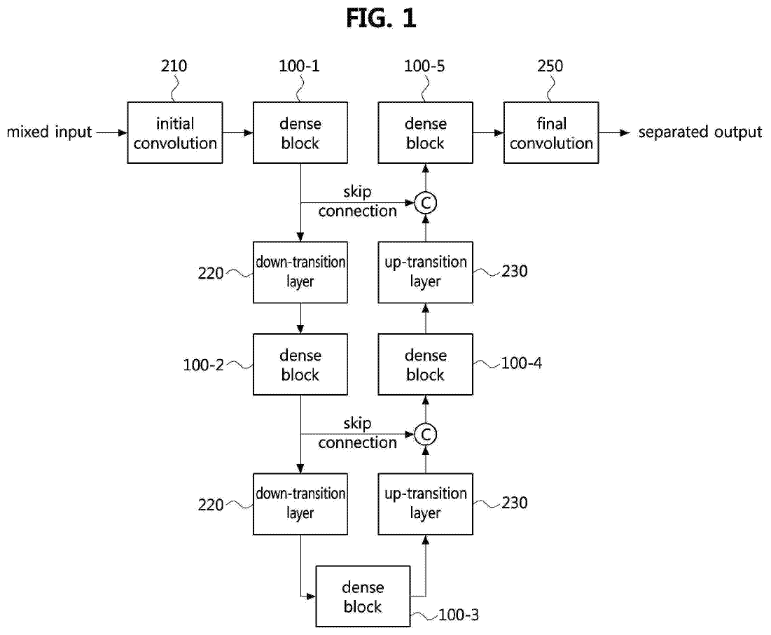

FIG. 1 is a structural diagram of a convolutional neural network used for sound source separation according to an exemplary embodiment of the present disclosure.

A convolutional neural network applied to the sound source separation according to the present disclosure may include an initial convolution unit 210, one or more dense blocks 100-1, 100-2, 100-3, 100-4, and 100-5, one or more down-transition layers 220, one or more up-transition layers 230, and a final convolution unit 250.

In general, a broadcast audio uses a high-quality sound source having a high sampling frequency such as 44 kHz. Accordingly, processing efficiency can be improved by performing resizing or resampling through down-sampling on a sound source having a high sampling frequency to 22,050 Hz through a signal preprocessor (not shown).

The initial convolution unit 210 may perform initial convolution and down-sampling on an input signal in which music, dialogue, and noise resampled through the preprocessing are mixed. Here, the initial convolution may be a one-dimensional convolution. In addition, the down-sampling may be performed, for example, through decimation, and the decimation is a process of reducing a sampling rate of the signal. That is, the decimation is the opposite of interpolation for increasing a sampling rate, and the decimation may convert the sampling rate.

In the initial convolution performed by the initial convolution unit 210, the convolution may be performed in a specific kernel size (i.e., kernel_size). In this case, appropriate zero padding may be provided so that the size of the sample does not change after the convolution.

After the preprocessing, an encoding process may be performed. In the encoding process, the dense block 100 and the down-transition layer 220 may be repeatedly executed to extract a feature of a signal in which only music is separated. In the exemplary embodiment shown in FIG. 1, a case in which the dense block and the down-transition layer are repeatedly executed two times is illustrated, but the number s of repetitions may be adjusted as necessary.

After the encoding process, the dense block 100 and the up-transition layer 230 may be repeatedly executed to derive a signal having the same dimension as the original sound through a decoding process. In this case, referring to FIG. 1, an output of each step of the encoding part may be connected to an output of the same layer of the decoding part to provide a skip connection.

In order to separate only a music signal from an output vector of the final dense block 100-5 in the decoding process, the music signal and the dialogue signal may be finally separated and extracted with a length equal to an input length through convolution and down-sampling in the final convolution unit 250. In the down-sampling performed by the final convolution unit 250, in order to reduce the size of the sample by half, a method of simply taking one sample and discarding the next sample may be performed repeatedly without using a pooling scheme generally used in the image technology field. This is to minimize damages in continuity of samples or to minimize distortion of the sound source.

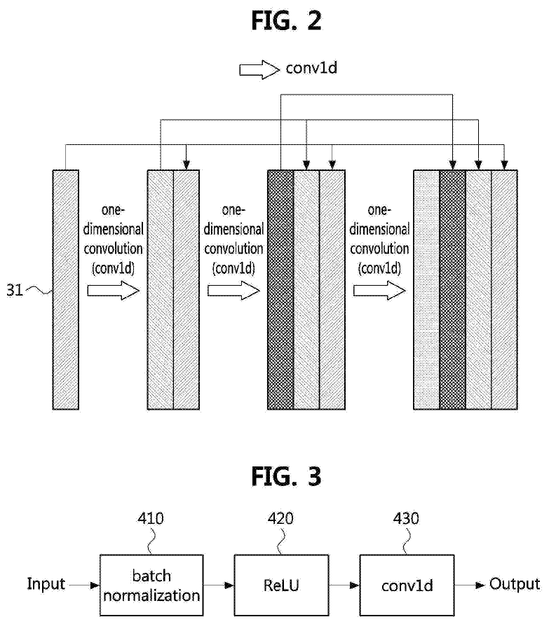

FIG. 2 is a conceptual diagram of a dense block applied to the present disclosure.

The dense block may be composed of k initial feature maps and L convolution layers. FIG. 2 shows the dense block for a case when layer L=3, and in FIG. 2, one arrow indicates one convolutional layer. In FIG. 2, an input vector 31 represents the dimension of the input signal on the vertical axis and the number of feature maps on the horizontal axis. The dense block may perform on convolution on the input signal, and the dense block may not only connect an output of a previous convolution to an input of a next convolution but also connect outputs of all previous convolutions from the initial input to an input of a next convolution. This may help to perform the learning process more smoothly, and may have an effect of achieving similar performance with fewer parameters.

The dense block is a block that can be used in both the down-sampling process, which is the encoding step, and the up-sampling process, which is the decoding step. The kernel size may be set differently when performing the convolution included in the dense block. L may also be set differently depending on the layer. In an exemplary embodiment, when s (the number of repetitions of the dense block and transition layer) is 6, L may be set to [4, 8, 12, 16, 20, 24].

FIG. 3 is a block diagram illustrating a convolution block according to an exemplary embodiment of the present disclosure.

The convolution block shown in FIG. 3 may be used in, for example, the signal preprocessor, and the final convolution unit and the dense block shown in FIG. 1. The convolution block according to an exemplary embodiment of the present disclosure may apply a batch normalization 410 and a rectified linear unit (ReLU) activation function 420 before performing convolution, and then perform a one-dimensional convolution 430 having the same variables as the initial convolution.

A batch may be understood as some data randomly selected during each training among all training data, and the batch normalization is an operation of normalizing the distribution of the batches in each layer of a neural network. In an exemplary embodiment of the present disclosure, a ReLU function may be used as the activation function used in the convolution block. When an input to the ReLU function exceeds 0, the ReLU function may output the input as it is, and when the input to the ReLU function does not exceed 0, the ReLU function may output 0.

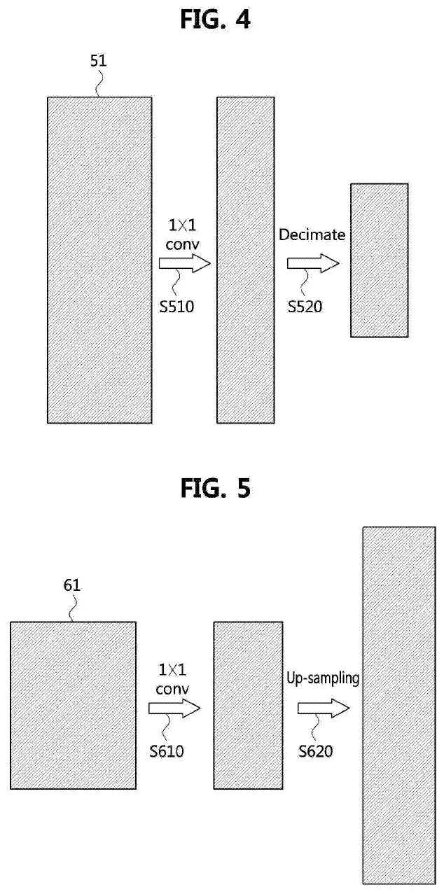

FIG. 4 is a conceptual diagram of a down-transition layer according to an exemplary embodiment of the present disclosure.

Referring to FIG. 4, in the down-transition layer, 1×1 convolution (S510) may be performed to reduce the number of feature maps 51 increased through the processing by the dense block. In this case, the number of feature maps of the previous input may be reduced according to a ratio θ of reducing the number. In this case, θ may have a value between 0 and 1. Thereafter, the number of feature maps and the length of the input signal may be reduced through a down-sampling step (S520).

FIG. 5 is a conceptual diagram of an up-transition layer according to an exemplary embodiment of the present disclosure.

Referring to FIG. 5, even in the up-transition layer, 1×1 convolution (S610) may be performed to reduce the number of feature maps 61 of the output of the dense block received as the input in the same manner as the down-transition layer. Thereafter, the length of the input signal may be doubled through an up-sampling step (S620).

When using a transposed convolution scheme generally used in the image field for the up-sampling, the convolution may be performed by adding zeros between samples. In this case, distortion with high frequency components may be generated due to the added zeros. Unlike a video signal, since the distortion of the high-frequency components may be easily generated in a music signal due to a distortion of one sample, in order to prevent this, an exemplary embodiment of the present disclosure may perform a bilinear resize to enable up-sampling while reducing the distortion. By increasing the length of the feature vector through the up-transition layer as much as the length reduced in the down-transition layer, the length of the initial input may be maintained even after passing through the network.

Returning to FIG. 1, in the final convolution 250, outputs having the same length as the input signal may be extracted as many as the number of sound sources.

For example, when the length of the input signal is composed of 16,384 samples, and the purpose is to separate a sound source to be separated into two portions, a background music and a non-background music, the final output of the network may be 16,384×2. That is, a background music portion consisting of 16,384 samples and a non-background music portion consisting of 16,384 samples may be output.

Meanwhile, a loss function L(x,y) for training the convolutional neural network is shown in Equation 1 below.

L(x, y)=∥f(x)−y∥₂ [Equation 1]

In Equation 1, f (·) denotes the convolutional neural network proposed in the present disclosure, x denotes the mixed input signal, and y=[m, s] denotes a music signal m and a signal s that is not music by associating them. That is, the convolutional neural network according to the present disclosure is trained as a network that minimizes a difference between a result of separating the input signal and each sound source constituting the mixed signal. According to another exemplary embodiment of the present disclosure, in the case of separating each instrument from music, y may associate signals as many as the number of instruments to be separated, and f(x) may output a signal having feature maps as many as the same number of instruments.

According to the present disclosure, unlike the prior art, since the input signal is connected to all convolution layers afterwards, it is possible to achieve more excellent performance with only a small number of parameters.

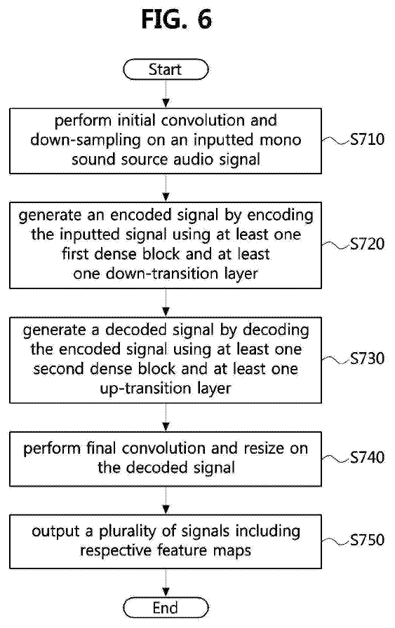

FIG. 6 is a flowchart for describing a method for separating a sound source based on a convolutional neural network according to an exemplary embodiment of the present disclosure.

In the method for separating a sound source based on a convolutional neural network according to an exemplary embodiment of the present disclosure, a mono sound source audio signal including phase information is received as an input and separated into a plurality of signals.

More specifically, initial convolution and down-sampling may be performed on the input audio signal (S710). In this case, the audio signal may be a mixed signal of a mono sound source, that is, a signal including voice, music, and noise.

For the audio signal for which the initial convolution and down-sampling have been completed, the input signal may be encoded using at least one first dense block and at least one down-transition layer (S720). Here, the down-transition layer may perform convolution for reducing the number of feature maps output by each of the at least one first dense block, and down-sampling for the feature maps output by the convolution for reducing the number of feature maps output by each of the at least one first dense block.

When the encoding process is completed, the encoded signal may be decoded using at least one second dense block and at least one up-transition layer (S730). The up-transition layer may perform convolution for reducing the number of feature maps output by each of the at least one second dense block, and up-sampling layer for the feature maps output by the convolution for reducing the number of feature maps output by each of the at least one second dense block.

Here, the up-sampling may be performed to maintain an initial input length of an initial feature map by increasing a length of a feature vector by a length of the feature vector reduced through the down-transition layer. The up-sampling may be performed through bilinear resize.

Meanwhile, the output of the first dense block may be connected to the output of the corresponding up-transition layer.

In addition, each of the at least one first dense block and the at least one second dense block may include one or more convolutions performed on the input initial feature map, and a value obtained by concatenating the result of the first convolution on the initial feature map and the initial feature map may be provided as the input of the second convolution.

Final convolution and resize may be performed on the decoded signal (S740), and a plurality of signals including respective feature maps may be output (S750).

Meanwhile, the initial convolution, the final convolution, the convolution included in the at least one first dense block, and the convolution included in the at least one second dense block may include a batch normalization for normalizing the distribution of the batches, activation function, and one-dimensional convolution.

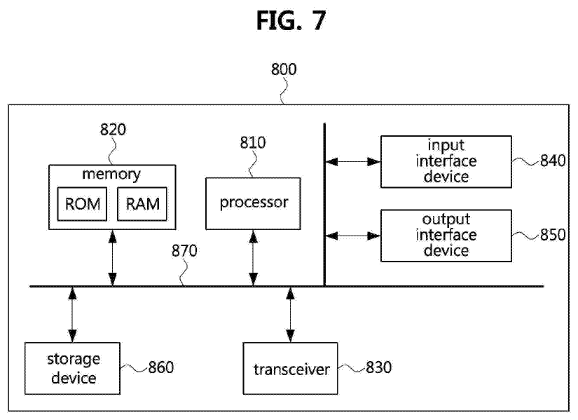

FIG. 7 is a block diagram illustrating an apparatus for separating a sound source based on a convolutional neural network according to an exemplary embodiment of the present disclosure.

The apparatus 800 for separating a sound source according to an exemplary embodiment of the present disclosure may comprise at least one processor 810, a memory 820 storing at least one instruction executable by the processor 810, and a transceiver 830 connected to a network to perform communication. In addition, the apparatus 800 may further include an input interface device 840, an output interface device 850, a storage device 860, and the like. The components included in the apparatus 800 may be connected by a bus 870 to communicate with each other.

The processor 810 may execute the at least one instruction stored in at least one of the memory 820 and the storage device 860. The processor 810 may refer to a central processing unit (CPU), a graphics processing unit (GPU), or a dedicated processor on which the methods according to the exemplary embodiments of the present disclosure are performed. Each of the memory 820 and the storage device 860 may be configured as at least one of a volatile storage medium and a nonvolatile storage medium. For example, the memory 820 may be configured with at least one of a read only memory (ROM) and a random access memory (RAM).

Particularly, the at least one instruction may cause the processor to perform initial convolution and down-sampling on the inputted mono sound source audio signal; generate an encoded signal by encoding the inputted signal using at least one first dense block and at least one down-transition layer; generate a decoded signal by decoding the encoded signal using at least one second dense block and at least one up-transition layer; and perform final convolution and resize on the decoded signal.

In this case, the audio signal may be a mixed signal of a mono sound source, that is, a signal including voice, music, noise, etc. An output of each of the at least one first dense block may be connected to an output of a corresponding up-transition layer.

In addition, each of the at least one first dense block and the at least one second dense block may include one or more convolutions performed on an input initial feature map, and a value obtained by concatenating a result of a first convolution on the initial feature map and the initial feature map may be provided as an input of a second convolution.

In addition, the down-transition layer may perform convolution for reducing a number of feature maps output by each of the at least one first dense block; and down-sampling for feature maps output by the convolution for reducing the number of feature maps output by each of the at least one first dense block.

In addition, the up-transition layer may perform convolution for reducing a number of feature maps output by each of the at least one second dense block; and up-sampling for feature maps output by the convolution for reducing the number of feature maps output by each of the at least one second dense block.

Meanwhile, each of the initial convolution, the final convolution, convolution performed in the at least one first dense block, and convolution performed in the at least one second dense block may include batch normalization to normalize a distribution of batches, an activation function, and a one-dimensional convolution.

The method according to the exemplary embodiments of the present disclosure may also be embodied as computer readable programs or codes on a computer readable recording medium. The computer readable recording medium is any data storage device that may store data which can be thereafter read by a computer system. The computer readable recording medium may also be distributed over network coupled computer systems so that the computer readable code is stored and executed in a distributed fashion.

In addition, examples of the computer-readable recording medium may include magnetic media such as hard discs, floppy discs, and magnetic tapes, optical media such as compact disc-read-only memories (CD-ROMs), digital video disc (DVDs), and so on, magneto-optical media such as floptical discs, and hardware devices specially configured (or designed) for storing and executing program commands, such as ROMs, random access memories (RAMs), flash memories, and so on. Examples of a program command may not only include machine language codes, which are created by a compiler, but may also include high-level language codes, which may be executed by a computer using an interpreter, and so on.

Some aspects of the present disclosure have been described in the context of an apparatus but may also represent the corresponding method. Here, a block or the apparatus corresponds to an operation of the method or a characteristic of an operation of the method. Likewise, aspects which have been described in the context of the method may be indicated by the corresponding blocks or items or characteristics of the corresponding apparatus. Some or all of operations of the method may be performed by (or using) a hardware device, such as a microprocessor, a programmable computer, or an electronic circuit. In some exemplary embodiments, one or more important steps of the method may be performed by such a device. In the exemplary embodiments of the present disclosure, a programmable logic device (e.g., a field-programmable gate array (FPGA)) may be used to perform some or all of functions of the above-described methods. In the exemplary embodiments, the FPGA may operate in combination with a microprocessor for performing one of the above-described methods. In general, the methods may be performed by any hardware device.

While the exemplary embodiments of the present disclosure and their advantages have been described in detail, it should be understood that various changes, substitutions and alterations may be made herein without departing from the scope of the disclosure.

What is claimed is:

1. A method for receiving a mono sound source audio signal including phase information as an input, and separating into a plurality of signals, the method comprising:
performing initial convolution and down-sampling on the inputted mono sound source audio signal;
generating an encoded signal by encoding the inputted signal using at least one first dense block and at least one down-transition layer;
generating a decoded signal by decoding the encoded signal using at least one second dense block and at least one up-transition layer; and
performing final convolution and resize on the decoded signal.

2. The method according to claim 1, wherein an output of each of the at least one first dense block is connected to an output of a corresponding up-transition layer.

3. The method according to claim 1, wherein each of the at least one first dense block and the at least one second dense block includes one or more convolutions performed on an input initial feature map, and a value obtained by concatenating a result of a first convolution on the initial feature map and the initial feature map is provided as an input of a second convolution.

4. The method according to claim 1, wherein the down-transition layer performs convolution for reducing a number of feature maps output by each of the at least one first dense block; and down-sampling for feature maps output by the convolution for reducing the number of feature maps output by each of the at least one first dense block.

5. The method according to claim 1, wherein the up-transition layer performs convolution for reducing a number of feature maps output by each of the at least one second dense block; and up-sampling for feature maps output by the convolution for reducing the number of feature maps output by each of the at least one second dense block.

6. The method according to claim 5, wherein the up-sampling is performed to maintain an initial input length of an initial feature map by increasing a length of a feature vector by a length of the feature vector reduced through the down-transition layer.

7. The method according to claim 5, wherein the up-sampling is performed through a bilinear resize.

8. The method according to claim 1, wherein each of the initial convolution, the final convolution, convolution performed in the at least one first dense block, and convolution performed in the at least one second dense block includes batch normalization to normalize a distribution of batches, an activation function, and a one-dimensional convolution.

9. The method according to claim 1, further comprising outputting the plurality of signals including a feature map for each of the plurality of signals as a result of performing the final convolution and resize.

10. The method according to claim 1, wherein the resize on the decoded signal is performed in a manner of taking a first sample and discarding a second sample following the first sample.

11. An apparatus for separating a mono sound source audio signal including phase information into a plurality of signals, the apparatus comprising:
a processor; and
a memory storing at least one instruction executable by the processor,
wherein when executed by the processor, the at least one instruction causes the processor to:
perform initial convolution and down-sampling on the inputted mono sound source audio signal;
generate an encoded signal by encoding the inputted signal using at least one first dense block and at least one down-transition layer;
generate a decoded signal by decoding the encoded signal using at least one second dense block and at least one up-transition layer; and
perform final convolution and resize on the decoded signal.

12. The apparatus according to claim 11, wherein an output of each of the at least one first dense block is connected to an output of a corresponding up-transition layer.

13. The apparatus according to claim 11, wherein each of the at least one first dense block and the at least one second dense block includes one or more convolutions performed on an input initial feature map, and a value obtained by concatenating a result of a first convolution on the initial feature map and the initial feature map is provided as an input of a second convolution.

14. The apparatus according to claim 11, wherein the down-transition layer performs convolution for reducing a number of feature maps output by each of the at least one first dense block; and down-sampling for feature maps output by the convolution for reducing the number of feature maps output by each of the at least one first dense block.

15. The apparatus according to claim 11, wherein the up-transition layer performs convolution for reducing a number of feature maps output by each of the at least one second dense block; and up-sampling for feature maps output by the convolution for reducing the number of feature maps output by each of the at least one second dense block.

16. The apparatus according to claim 15, wherein the up-sampling is performed to maintain an initial input length of an initial feature map by increasing a length of a feature vector by a length of the feature vector reduced through the down-transition layer.

17. The apparatus according to claim 15, wherein the up-sampling is performed through a bilinear resize.

18. The apparatus according to claim 11, wherein each of the initial convolution, the final convolution, convolution performed in the at least one first dense block, and convolution performed in the at least one second dense block includes batch normalization to normalize a distribution of batches, an activation function, and a one-dimensional convolution.

19. The apparatus according to claim 11, wherein the at least one instruction further causes the processor to output the plurality of signals including a feature map for each of the plurality of signals as a result of performing the final convolution and resize.

20. The apparatus according to claim 11, wherein the resize on the decoded signal is performed in a manner of taking a first sample and discarding a second sample following the first sample.
